(19) United States
(12) Patent Application Publication
(10) Pub. No.: US 2011/0309280 A1
(43) Pub. Date: Dec. 22, 2011

(54) SELF CLEANING BALL VALVE

(76) Inventor: Christopher P. Wincek, Rancho Santa Margarita, CA (US)

(21) Appl. No.: 13/164,746

(22) Filed: Jun. 20, 2011

Related U.S. Application Data
(60) Provisional application No. 61/397,899, filed on Jun. 18, 2010.

(51) Int. Cl. F16K 5/06

(52) U.S. Cl. 251/315.01

(57) ABSTRACT

A ball valve has a valve body having proximal and distal portions, a seat assembly that is compressed by the valve body, a flow control ball, and an actuator for actuating the flow control ball between open and closed positions. The seat assembly may include proximal and distal seats, a medial gasket, and O-rings. The flow control ball has a ball body having an outer surface that includes at least one shoulder and a neck, the at least one shoulder having a larger radius than the neck.

### CROSS-REFERENCE TO RELATED APPLICATIONS

This application for a utility patent claims the benefit of U.S. Provisional Application No. 61/397,899, filed Jun. 18, 2011.

### STATEMENT REGARDING FEDERALLY SPONSORED RESEARCH

Not Applicable

### BACKGROUND OF THE INVENTION

1. Field of the Invention

This invention relates generally to valves, and more particularly to a self cleaning ball valve.

2. Description of Related Art

There are no ball valves currently on the market that are suitable for processing dairy and similar fluids, that are capable of being cleaned in place (“CIP'able”). Most of these types of valves are cleaned manually, at considerable expense.

Friedline, et al., U.S. Pat. No. 6,267,353, teaches a ball valve that attempts to reach this goal. The Friedline reference teaches a ball valve that enables flow behind the ball for automated cleaning; however, it teaches a floating seat construction. In practice, this floating seal has not been successful, and is not currently certified as CIP'able.

Yeary, U.S. 2008/0105845, teaches a quarter-turn ball valve that enables the removal of solid matter that becomes trapped in the valve. Further examples of prior art valves are shown in Rogers (U.S. Pat. Nos. 4,124,036, and 4,136,709), and Hutchens, et al., U.S. Pat. No. 4,846,213. The above-described references are hereby incorporated by reference in full.

The prior art teaches various forms of ball valves. However, the prior art does not teach a ball valve that is CIP'able and able to be completely cleaned using automated cleaning techniques. The present invention fulfills these needs and provides further related advantages as described in the following summary.

### SUMMARY OF THE INVENTION

The present invention teaches certain benefits in construction and use which give rise to the objectives described below.

The present invention provides a ball valve for controlling the flow of a fluid. The ball valve comprises a valve body having a proximal portion and a distal portion that together define an interior space, the proximal portion having a proximal port and the distal portion having a distal port; a proximal seat shaped to fit within the proximal portion; a distal seat shaped to fit within the distal portion; a medial gasket that fits between the proximal and distal seats; a clamping element that clamps the proximal and distal portions of the valve body together to compress the proximal and distal seats and the medial gasket to form a fluid flow space that enables the fluid to flow from the proximal port to the distal port, but does not allow any of the fluid to leak between the proximal or distal seats and the valve body; a flow control ball comprising a ball body having an outer surface that includes at least one shoulder and a neck, the at least one shoulder having a larger radius than the neck; and a flow passage through the ball body; an actuator stem extending from the flow control ball for rotating the flow control ball between a closed position wherein the at least one shoulder sealingly engage the proximal and/or distal seats, and an open position wherein the flow passage is aligned with the proximal and distal ports to allow the flow of the fluid through the flow passage and around the neck of the ball body; and an aperture through the medial gasket for receiving the actuator stem therethrough such that the medial gasket seals against the actuator stem.

A primary objective of the present invention is to provide a ball valve having advantages not taught by the prior art.

Another objective is to provide a ball valve that is “cleanable in place” (“CIP'able”) so that it may be completely sanitized using automated cleaning techniques that do not require the removal and manual cleaning of the ball valve.

A further objective is to provide a ball valve that is inexpensive to operate and maintain, while maintaining the highest standards of cleanliness required for processing dairy products and similar fluids.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a ball valve according to one embodiment of the present invention;

FIG. 2 is an exploded side elevational cross-sectional view of the ball valve;

FIG. 3 is a perspective view of a flow control ball of the ball valve; and

FIG. 4 is a sectional view of the assembled ball valve, illustrating the flow control ball in an open position; and

FIG. 5 is a sectional view thereof illustrating the flow control ball turned to a closed position.

### DETAILED DESCRIPTION OF THE INVENTION

The above-described drawing figures illustrate the invention, a ball valve 10 for controlling the flow of a fluid through a conduit (not shown), typically for use in food processing (e.g., dairy products, etc.) where strict sanitary conditions are required. The ball valve 10 is adapted to be cleanable in place (“CIP'able”), without requiring the removal, disassembly, and manual cleaning of the valve 10 between uses.

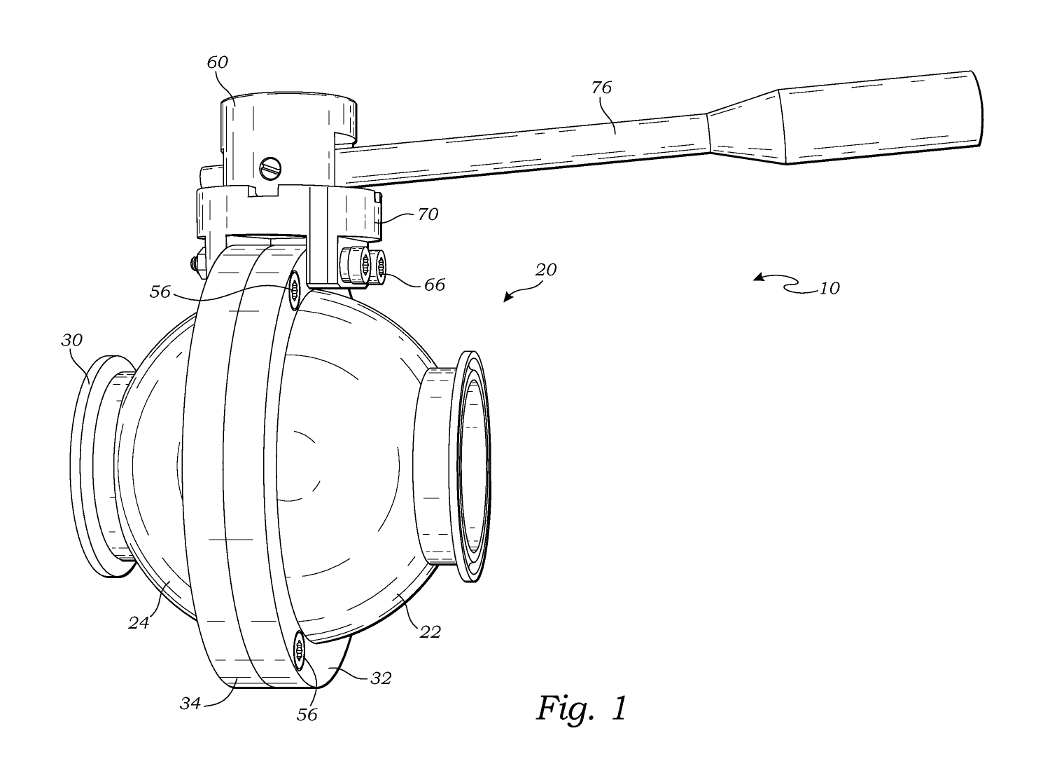

FIG. 1 is a perspective view of the ball valve 10 according to one embodiment of the present invention. As illustrated in FIG. 1, the ball valve 10 includes a valve body 20, a handle assembly 60, and a handle 76 that is used to operably control the ball valve 10. While the handle 76 illustrated represents one simple and manual embodiment, in alternative embodiments the ball valve 10 may also be operably controlled by pneumatic or electronic controls (not shown), or other suitable controls well known in the art, and such alternative embodiments should be considered within the scope of the present invention.

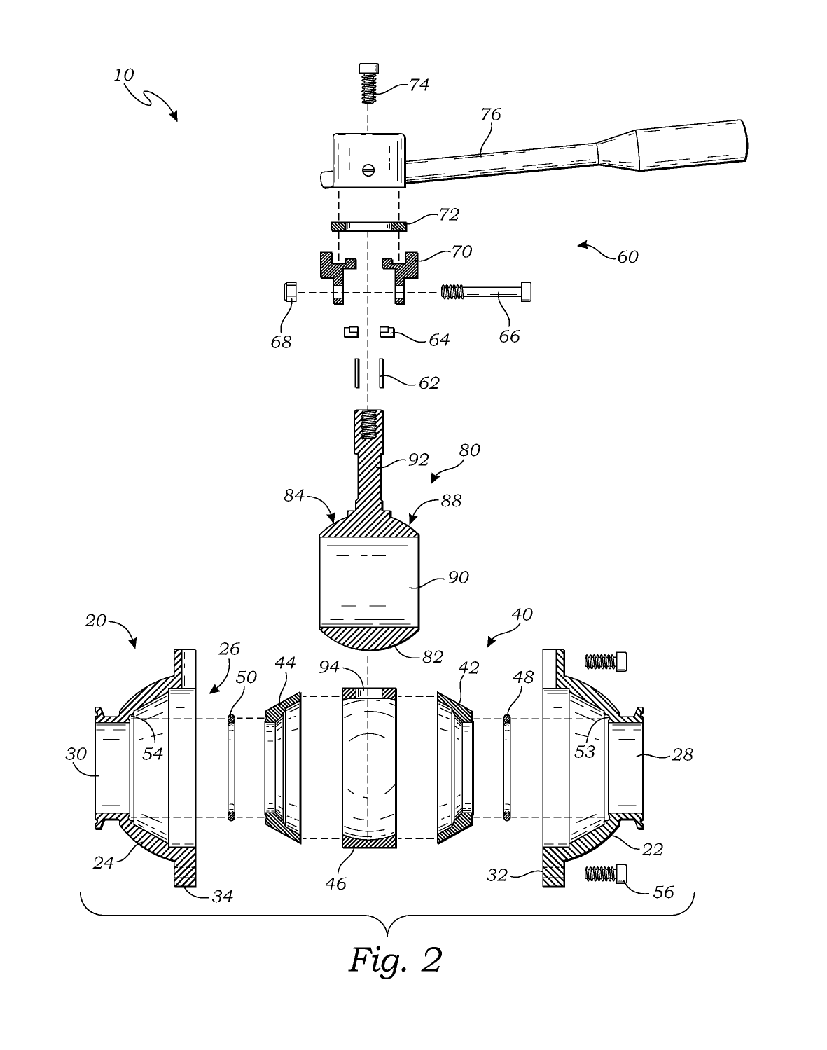

FIG. 2 is an exploded side elevational cross-sectional view of the ball valve 10 of FIG. 1. As shown in FIG. 2, the ball valve 10 comprises a valve body 20, a seat assembly 40, and a flow control ball 80. The valve body 20 includes a proximal portion 22 and a distal portion 24 that together define an interior space 26. The proximal portion 22 has a proximal port 28 and the distal portion 24 has a distal port 30. The proximal and distal ports 28 and 30 are adapted to be attached to existing conduit elements (not shown) using structures and methods that are well known in the art, and are therefore not described in greater detail herein.

In one embodiment, the proximal portion 22 and the distal portion 24 are each generally hemispherical in shape, and combine to form a generally spherical valve body 20. Other shapes may also be used, according to the design dictates of one skilled in the art.

As illustrated in FIG. 2, the seat assembly 40 includes a proximal seat 42 shaped to fit within the proximal portion 22, a distal seat 44 shaped to fit within the distal portion 24, and a medial gasket 46 that fits between the proximal and distal seats 42 and 44. The proximal and distal seats 42 and 44 are constructed of a material such as polytetrafluoroethylene (TFM™-PTFE) that provide a good seating surface with suitable wear characteristics, etc. The medial gasket 46 is constructed of a suitable resilient material such as rubber (e.g., EPDM), or other suitable material known to those skilled in the art.

It is critical that the fluids passing through the ball valve 10 not leak behind the proximal or distal seats 42 and 44. The medial gasket 46 is critical in this respect, as it forms a suitable sealing relationship with the proximal and distal seats 42 and 44 to prevent leakage. In one embodiment, the seat assembly 40 further includes proximal and distal O-rings 48 and 50 to prevent leakage around the other ends of the proximal and distal seats 42 and 44.

In one embodiment, the valve body 20 includes a proximal annular groove 53 in the proximal portion 22 of the valve body 20 adjacent the proximal port 28, shaped to receive the proximal O-ring 48 and position the proximal O-ring 48 to abut the proximal seat 42 and form a suitable seal to prevent leakage. Similarly, a distal annular groove 54 in the distal portion 24 of the valve body 20 adjacent the distal port 30 positions the distal O-ring 50 to abut and seal against the distal seat 44. The proximal and distal O-rings 48 and 50 are made of a suitable resilient material, such as rubber (or other suitable material), to form the necessary seal.

FIG. 2 also illustrates a clamping element 56 that clamps the proximal and distal portions 22 and 24 of the valve body 20 together to compress the proximal and distal seats 42 and 44, the medial gasket 46, and the proximal and distal O-rings 48 and 50 to form a fluid flow space that enables the fluid to flow from the proximal port 28 to the distal port 30, but does not allow any of the fluid to leak between the proximal or distal seats 42 and 44 and the valve body 20.

In the embodiment of FIG. 2, the valve body 20 includes proximal and distal flanges 32 and 34 extending from the proximal and distal portions 22 and 24 of the valve body 20, respectively. In this embodiment, the clamping element 56 includes fasteners (e.g., bolts, C-clamps, or other suitable elements known in the art) for clamping the proximal and distal flanges 32 and 34 together. In alternative embodiments, the clamping element 56 may include alternative constructions known in the art for joining and compressing the proximal and distal portions 22 and 24 towards each other, and such alternatives should be considered within the scope of the present invention.

In the embodiment of FIG. 2, the handle assembly 60 includes a bushing 62, a thrust bearing 64, a first screw 66 and a mating nut 68 for the first screw 66, an index base 70, a thrust washer 72, a second screw 74 for mounting the handle 76. Since the general construction of the handle assembly 60 may vary, and is well known in the art, it is not described in greater detail herein.

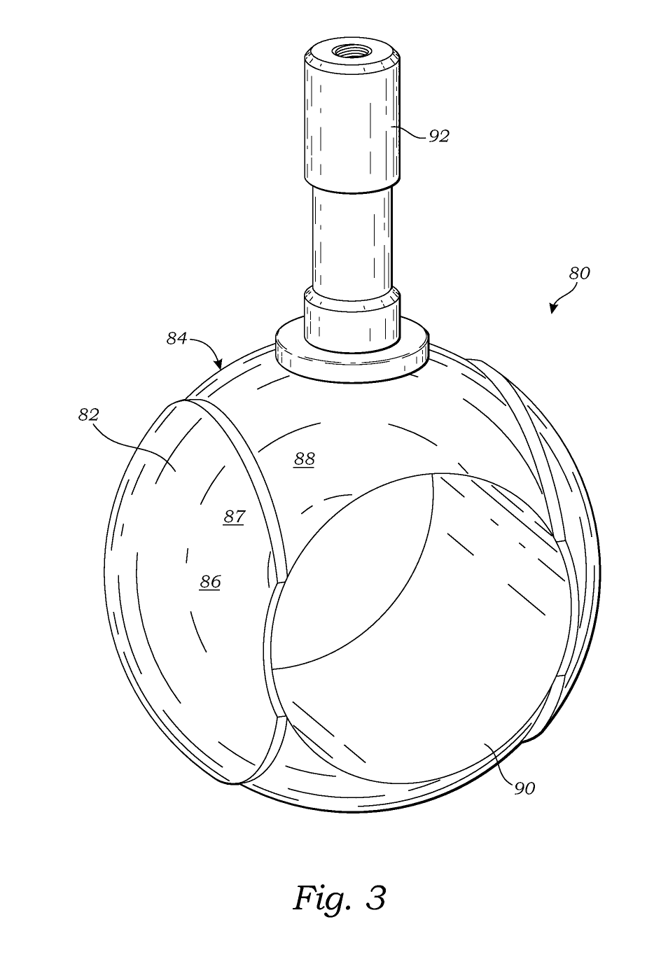

FIG. 3 is a perspective view of a flow control ball 80 of the ball valve 10. As illustrated in FIGS. 2 and 3, the flow control ball 80 includes a ball body 82 having an outer surface 84 that includes at least one shoulder 86 and a neck 88. The ball body 82 includes a flow passage 90 through the ball body 82 for allowing the fluid to flow through the flow control ball 80.

The at least one shoulder 86 may include a single shoulder 86 for blocking either the proximal port 28 or the distal port 30. In other embodiments, is may have two shoulders 86, such as two opposing shoulders 86 extending in opposite directions. It is also possible to have multiple shoulders 86, if the valve body 20 includes multiple ports. The shoulder 86 has a larger radius than the neck 88. While the shoulder 86 is shaped to seal against the proximal and/or distal seat 42 and 44 for closing the proximal and/or distal ports 28 and 30, the neck 88 has a smaller diameter so that fluid can flow around the ball body 82 as well as through the flow passage 90. Each shoulder 86 includes an annular sealing portion 87 that abuts one of the proximal or distal seats 42 and 44.

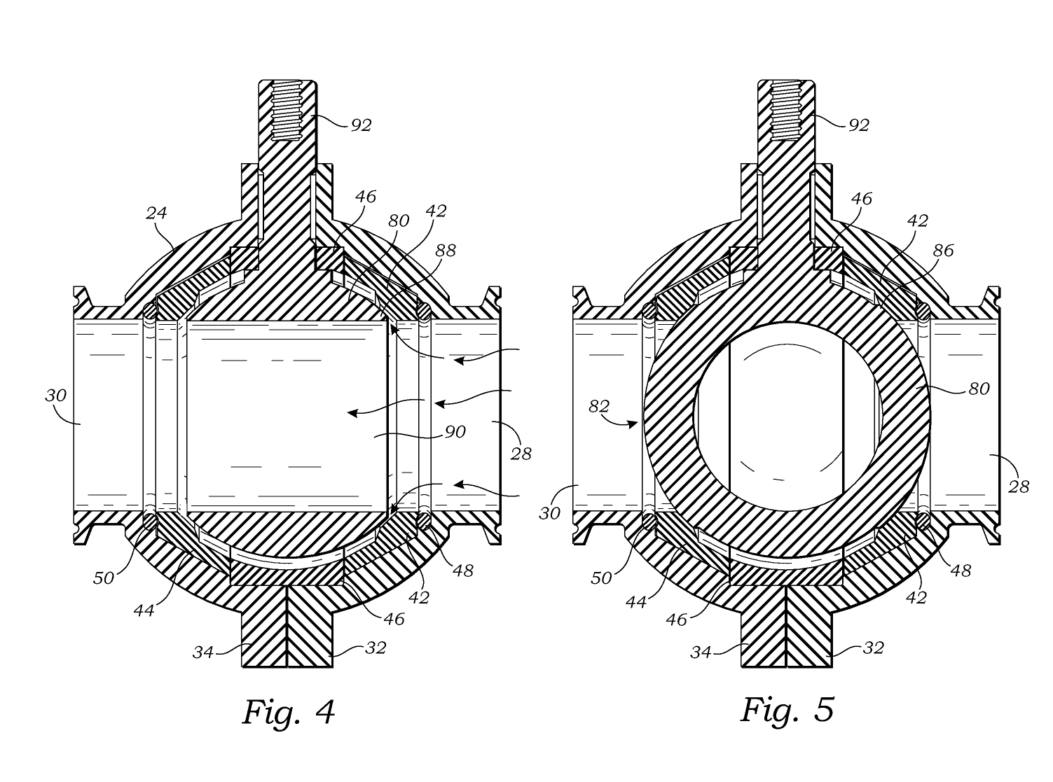

FIG. 4 is a sectional view of the assembled ball valve 10, illustrating the flow control ball 80 in an open position. In this position, the fluid can flow not only through the flow passage 90, but also around the outer surface 84 (illustrated in FIG. 3) of the flow control ball 80, around the neck 88.

FIG. 5 is a sectional view of the ball valve 10, illustrating the flow control ball 80 turned to a closed position, wherein the shoulders 86 are seated against the proximal and distal seats 42 and 44. In this position, there is no flow of the fluid through the ball valve 10.

As illustrated in FIGS. 1-5, the ball valve 10 includes an actuator stem 92 extending from the flow control ball 80 for rotating the flow control ball 80 between the open and closed positions. The medial gasket 46 includes an aperture 94 through the medial gasket 46 for receiving the actuator stem 92 therethrough such that the medial gasket 46 seals against the actuator stem 92. The construction of the medial gasket 46 is critical, because the aperture 94 must allow the actuator stem 92 to rotate, but prevent any leakage that would prevent thorough cleaning of the ball valve 10.

In operation, the proximal and distal O-rings 48 and 50 are placed in the proximal and distal annular grooves 53 and 54, the proximal and distal seats 42 and 44 and the medial gasket 46 are positioned with the proximal and distal portions 22 and 24 of the valve body 20, and the entire assembly is clamped together, such as by inserting bolts through the proximal and distal flanges 32 and 34 and tightening them. The tightening action functions to compress all of these elements together, so that the resilient sealing components form good seals against the proximal and distal seats 42 and 44. This prevents any of the fluids from leaking behind the seats, and preventing the automated cleaning from completely cleaning the ball valve 10.

The ball valve 10 is used in the processing of the fluid, such as milk, and when the cycle is completed and a new fluid is going to be processes (e.g., chocolate milk), it is necessary to clean the ball valve 10. A cleaning fluid is pumped through the system (not shown), including the ball valve 10. The ball valve 10 is actuated between the open and closed positions, so that the cleaning fluid can flow across and clean all of the ball valve 10. The cleaning fluid can flow not only through the flow passage 90, but also around the outer surface 84 of the flow control ball 80. The O-rings and the medial gasket 46 prevent any need to clean behind the proximal and distal seats 42 and 44.

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

What is claimed is:

1. A ball valve for controlling the flow of a fluid, the ball valve comprising:
a valve body having a proximal portion and a distal portion that together define an interior space, the proximal portion having a proximal port and the distal portion having a distal port;
a proximal seat shaped to fit within the proximal portion;
a distal seat shaped to fit within the distal portion;
a medial gasket that fits between the proximal and distal seats;
a clamping element that clamps the proximal and distal portions of the valve body together to compress the proximal and distal seats and the medial gasket to form a fluid flow space that enables the fluid to flow from the proximal port to the distal port, but does not allow any of the fluid to leak between the proximal or distal seats and the valve body;
a flow control ball comprising:
a ball body having an outer surface that includes at least one shoulder and a neck, the at least one shoulder having a larger radius than the neck; and
a flow passage through the ball body;
an actuator stem extending from the flow control ball for rotating the flow control ball between a closed position wherein the at least one shoulder sealingly engage the proximal and/or distal seats, and an open position wherein the flow passage is aligned with the proximal and distal ports to allow the flow of the fluid through the flow passage and around the neck of the ball body; and
an aperture through the medial gasket for receiving the actuator stem therethrough such that the medial gasket seals against the actuator stem.

2. The ball valve of claim 1, further comprising:
a proximal annular groove in the proximal portion of the valve body adjacent the proximal port, shaped to receive a proximal O-ring that abuts the proximal seat; and
a distal annular groove in the distal portion of the valve body adjacent the distal port, shaped to receive a distal O-ring that abuts the distal seat.

3. The ball valve of claim 1, further comprising proximal and distal flanges extending from the proximal and distal portions of the valve body, respectively, and wherein the clamping element includes fasteners for clamping the proximal and distal flanges together.

4. A ball valve for controlling the flow of a fluid, the ball valve comprising:
a valve body having a proximal portion and a distal portion that together define an interior space, the proximal portion having a proximal port and the distal portion having a distal port;
a proximal seat shaped to fit within the proximal portion;
a distal seat shaped to fit within the distal portion;
a medial gasket that fits between the proximal and distal seats;
a clamping element that clamps the proximal and distal portions of the valve body together to compress the proximal and distal seats and the medial gasket to form a fluid flow space that enables the fluid to flow from the proximal port to the distal port, but does not allow any of the fluid to leak between the proximal or distal seats and the valve body;
a flow control ball comprising:
a ball body having an outer surface that includes a pair of opposing shoulders and a neck, the shoulders having a larger radius than the neck; and
a flow passage through the ball body;
an actuator stem extending from the flow control ball for rotating the flow control ball between a closed position wherein the pair of shoulders sealingly engage the proximal and distal seats, and an open position wherein the flow passage is aligned with the proximal and distal ports to allow the flow of the fluid through the flow passage and around the neck of the ball body; and
an aperture through the medial gasket for receiving the actuator stem therethrough such that the medial gasket seals against the actuator stem.

5. The ball valve of claim 4, further comprising:
a proximal annular groove in the proximal portion of the valve body adjacent the proximal port, shaped to receive a proximal O-ring; and
a distal annular groove in the distal portion of the valve body adjacent the distal port, shaped to receive a distal O-ring.

6. The ball valve of claim 4, further comprising proximal and distal flanges extending from the proximal and distal portions of the valve body, respectively, and wherein the clamping element includes fasteners for clamping the proximal and distal flanges together.

7. A ball valve for controlling the flow of a fluid, the ball valve comprising:
a valve body having a proximal portion and a distal portion that together define an interior space, the proximal portion having a proximal port and the distal portion having a distal port;
a seat assembly comprising:
a proximal seat shaped to fit within the proximal portion;
a proximal O-ring positioned between the proximal seat and the proximal port of the valve body;
a distal seat shaped to fit within the distal portion;
a distal O-ring positioned between the distal seat and the distal port of the valve body; and
a medial gasket that fits between the proximal and distal seats;
a clamping element that clamps the proximal and distal portions of the valve body together to compress the proximal and distal O-rings, the proximal and distal seats, and the medial gasket, to form a leak-proof fluid flow space that allows the fluid to flow from the proximal port to the distal port, but does not allow any of the fluid to leak into the interior space;
a flow control ball comprising:
a ball body having an outer surface shaped to fit within the leak-proof fluid flow space;
a flow passage through the ball body; and
at least one shoulder extending outwardly from the ball body, wherein the radius of the at least one shoulder is equal to the radius of an annular sealing portion of the proximal and/or distal seats so that the at least one shoulder can sealingly engage the proximal and/or distal seats to prevent flow through the fluid flow space,
the flow control ball being rotable within the fluid flow space to move between a closed position wherein the at least one shoulder is sealingly engaged with the proximal and/or distal seats, and an open position wherein the flow passage is aligned with the proximal and distal ports to allow the flow of the fluid therebetween,
wherein the radius of outer surface of the ball body is less than the radius of the at least one shoulder, so that the fluid can flow around the ball body when the flow control ball is not in the closed position;
an actuator stem extending from the flow control ball for rotating the flow control ball between the open and closed positions; and
an aperture through the medial gasket for receiving the actuator stem therethrough such that the medial gasket seals against the actuator stem.

8. The ball valve of claim 7, further comprising:
a proximal annular groove in the proximal portion of the valve body adjacent the proximal port, shaped to receive the proximal O-ring; and
a distal annular groove in the distal portion of the valve body adjacent the distal port, shaped to receive the distal O-ring.

9. The ball valve of claim 7, further comprising proximal and distal flanges extending from the proximal and distal portions of the valve body, respectively, and wherein the clamping element includes fasteners for clamping the proximal and distal flanges together.
